(19) United States
(12) Patent Application Publication
(10) Pub. No.: US 2017/0254304 A1
(43) Pub. Date: Sep. 7, 2017

(54) FUEL INJECTION VALVE

(71) Applicant: DENSO CORPORATION, Kariya-city, Aichi-pref. (JP)

(72) Inventors: Shinsuke YAMAMOTO, Kariya-city (JP); Shinobu OIKAWA, Kariya-city (JP)

(21) Appl. No.: 15/509,323

(22) PCT Filed: Sep. 14, 2015
(86) PCT No.: PCT/JP2015/004678

§ 371 Date: Mar. 7, 2017

(30) Foreign Application Priority Data
Sep. 17, 2014 (JP) 2014-188846

(51) Int. Cl. F02M 51/06

(52) U.S. Cl. CPC F02M 51/0653

(57) ABSTRACT

In a fuel injection valve, when a regulating unit provided in a needle abuts against a movable core, a gap is defined between a flange portion end face of a flange portion and a movable core first end face of the movable core. With the above configuration, when a coil develops a magnetic field, because the movable core abuts against a flange portion while accelerating in a valve-opening direction, a relatively large force is exerted on the needle in the valve-opening direction. The needle is further moved in the valve-opening direction by an urging force of a second spring after the movable core has abutted against the fixed core. With the above configuration, a lift quantity of the needle is longer than a distance by which the movable core moves until the movable core abuts against a fixed core abutting portion since the movable core abuts against the flange portion. As a result, the lift quantity of the needle can be increased without any increase in the electric power to be supplied to the coil.

### CROSS REFERENCE TO RELATED APPLICATION

This application is based on Japanese Patent Application No. 2014-188846 filed on Sep. 17, 2014, the disclosure of which is incorporated herein by reference.

### TECHNICAL FIELD

The present disclosure relates to a fuel injection valve for injecting a fuel into an internal combustion engine.

### BACKGROUND ART

Up to now, a fuel injection valve in which an injection hole provided in a housing is opened and closed by a reciprocating motion of a needle, and a fuel in the housing is injected toward an outside has been known. For example, Patent Literature 1 discloses a fuel injection valve in which when the needle is abutted against a valve seat formed around an inner opening of the injection hole, a gap having a predetermined distance in a center axis direction of the housing is provided between the needle and a movable core.

In the fuel injection valve disclosed in Patent Literature 1, the movable core is moved in a valve-opening direction and abutted against the needle while being accelerated by a magnetic attraction force exerted between the movable core and a fixed core with the use of the gap between the movable core and the needle. With the above configuration, in the fuel injection valve disclosed in Patent Literature 1, a relatively large force for opening the valve is exerted on the needle.

However, in the fuel injection valve disclosed in Patent Literature 1, a distance by which the movable core moves after the movable core has been abutted against the needle when a valve is opened is identical with a distance (hereinafter referred to as “lift quantity”) by which the needle moves. For that reason, when the injection quantity of fuel is increased with an increase in the lift quantity, the distance by which the movable core moves after the movable core has been abutted against the needle must been lengthened, resulting in a need to increase a power to be supplied to a coil for generation of a magnetic field. Hence, there is a risk that a power consumption of the fuel injection valve is increased.

### PRIOR ART LITERATURES

### Patent Literature

Patent Literature 1: Japanese Patent No. 4637930

### SUMMARY OF INVENTION

It is an object of the present disclosure to provide a fuel injection valve capable of increasing an injection quantity of fuel with a small power consumption.

A fuel injection valve according to the present disclosure includes a housing, a fixed core, a needle member, a flange portion, a movable core, a regulating unit, a coil, a first urging member, and a second urging member. The needle member is disposed to be reciprocatingly movable in the housing, the valve is closed when one end portion of the needle member abuts against the valve seat, and the valve is opened when one end portion of the needle member is lifted from the valve seat. The flange portion is disposed radially outside of the other end portion of the needle member so as to be reciprocatingly movable integrally with the needle member. The movable core is disposed to be movable relative to the needle member on the valve seat side of the flange portion. The regulating unit is disposed radially outside of the needle member on the valve seat side of the flange portion so as to be reciprocatingly movable integrally with the needle member, and can regulate the movement of the movable core in the valve-closing direction when abutting against the movable core. The first urging member urges the needle member in the valve-closing direction. The second urging member has one end abutting against the regulating unit, and urges the needle member in the valve-opening direction through the regulating unit. In the fuel injection valve according to the present disclosure, when the regulating unit abuts against the movable core, the gap is defined between the flange portion and the movable core.

In the fuel injection valve according to the present disclosure, when the regulating unit abuts against the movable core, the gap is defined between the flange portion and the movable core. When the power is supplied to the coil at the time of opening the valve, the movable core moves while accelerating in the valve-opening direction with the use of the gap, and abuts against the flange portion. As a result, the relatively large force in the valve-opening direction can be exerted on the needle.

In addition, in the fuel injection valve according to the present disclosure, the second urging member abuts against the regulating unit disposed radially outside of the needle member so as to be reciprocatingly movable integrally with the needle member. The second urging member urges the needle member in the valve-opening direction through the regulating unit. In the case where the movable core is attracted to the fixed core to open the fuel injection valve, when the movable core abuts against the fixed core after the movable core moving in the valve-opening direction has abutted against the flange portion, the needle member is spaced apart from the movable core due to the urging force of the second urging member, and further moves in the valve-opening direction. As a result, the lift quantity of the needle member is longer than the distance by which the movable core moves until the movable core abuts against the fixed core since the movable core abuts against the flange portion. Therefore, in the fuel injection valve according to the present disclosure, the lift quantity of the needle member is increased without any increase in the electric power to be supplied to the coil, as a result of which the injection quantity of fuel can be increased.

### BRIEF DESCRIPTION OF DRAWINGS

The above-described purpose and the other purposes of the present disclosure, as well as the features and advantages of the present disclosure, will be further clarified in the following detailed description and with reference to accompanying drawings.

FIG. 1 is a cross-sectional view of a fuel injection valve according to a first embodiment of the present disclosure.

FIG. 2 is an enlarged view of a part II in FIG. 1.

FIG. 3 is an enlarged view of a part II in FIG. 1, which illustrates an action different from that in FIG. 2.

FIG. 4 is an enlarged view of a part II in FIG. 1, which illustrates an action different from that in FIGS. 2 and 3.

FIG. 5 is an enlarged view of a part II in FIG. 1, which illustrates an action different from that in FIGS. 2, 3, and 4.

FIG. 6 is a characteristic diagram illustrating a relationship between a lift quantity of a needle and a force exerted on the needle in the fuel injection valve according to the first embodiment of the present disclosure.

FIG. 7 is a cross-sectional view of a fuel injection valve according to a second embodiment of the present disclosure.

FIG. 8 is a cross-sectional view of the fuel injection valve according to the second embodiment of the present disclosure, which illustrates an action different from that in FIG. 7.

FIG. 9 is a cross-sectional view of a fuel injection valve according to a third embodiment of the present disclosure.

FIG. 10 is a cross-sectional view of a fuel injection valve according to a third embodiment of the present disclosure, which illustrates an action different from that in FIG. 9.

FIG. 11 is a cross-sectional view of a fuel injection valve according to a fourth embodiment of the present disclosure.

### EMBODIMENTS FOR CARRYING OUT INVENTION

Hereinafter, embodiments of the present disclosure will be described with reference to drawings.

### First Embodiment

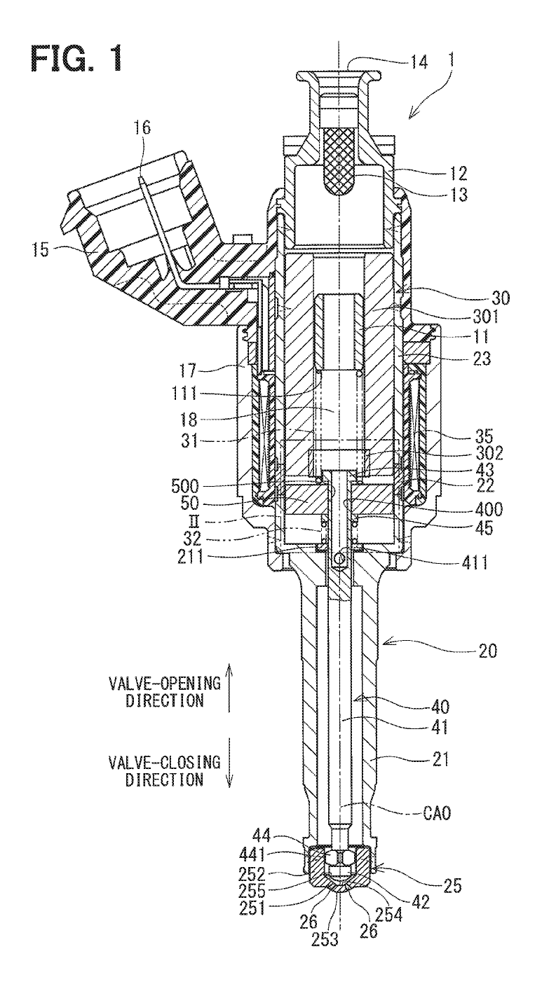

A fuel injection valve 1 according to a first embodiment of the present disclosure is illustrated in FIGS. 1 to 6. FIGS. 1 to 5 illustrate a valve-opening direction and a valve-closing direction in which the valve-opening direction is a direction in which a needle 40 is spaced apart from a valve seat 255 and the valve-closing direction is a direction in which the needle 40 abuts against the valve seat 255.

A fuel injection valve 1 is used in a fuel injection device for a direct injection gasoline engine not shown and injects a gasoline as a fuel into an engine with a high pressure. The fuel injection valve 1 includes a housing 20, the needle 40, a movable core 50, a fixed core 30, a coil 35, a first spring 31 as a “first urging member”, a second spring 32 as a “second urging member”, and so on. Incidentally, the fuel injected by the fuel injection valve according to the present disclosure is not limited to the gasoline. The fuel may be a light oil.

As illustrated in FIG. 1, the housing 20 includes a first cylinder member 21, a second cylinder member 22, a third cylinder member 23, and an injection nozzle 25. Each of the first cylinder member 21, the second cylinder member 22, and the third cylinder member 23 is formed in a cylindrical shape, and the first cylinder member 21, the second cylinder member 22, and the third cylinder member 23 are coaxially disposed in the stated order and are connected to each other.

The first cylinder member 21 and the third cylinder member 23 are made of a magnetic material such as ferritic stainless steel, and subjected to a magnetic stabilization treatment. The first cylinder member 21 and the third cylinder member 23 are relatively low in hardness. On the other hand, the second cylinder member 22 is made of a nonmagnetic material such as austenitic stainless steel. The second cylinder member 22 is higher in hardness than the first cylinder member 21 and the third cylinder member 23.

The injection nozzle 25 is disposed on an end portion of the first cylinder member 21 on a side opposite to the second cylinder member 22. The injection nozzle 25 is formed in a bottomed cylindrical shape, made of a metal such as martensitic stainless steel, and welded to the first cylinder member 21. The injection nozzle 25 is subjected to a quenching treatment so as to provide a predetermined hardness. The injection nozzle 25 includes an injection portion 251 and a cylinder portion 252.

The injection portion 251 is axisymmetrically formed with respect to a central axis CA0 of the housing 20, which is coaxial with a central axis of the fuel injection valve 1, as an axis of symmetry. An outer wall 253 of the injection portion 251 protrudes from an interior of the injection nozzle 25 in the direction of the central axis CA0. The injection portion 251 has multiple injection holes 26 that communicate an inside and an outside of the housing 20 with each other. A valve seat 255 is formed around openings inside of the injection holes provided in an inner wall 254 of the injection portion 251,

The cylinder portion 252 surrounds a radial outside of the injection portion 251 and extends in a direction opposite to a direction in which the outer wall 253 of the injection portion 251 protrudes. The cylinder portion 252 has one end portion connected to the injection portion 251 and the other end portion connected to the first cylinder member 21.

The needle 40 is made of a metal such as martensitic stainless steel. The needle 40 is subjected to a quenching treatment so as to provide a hardness comparable to the hardness of the injection nozzle 25.

The needle 40 is housed in the housing 20 to be reciprocatingly movable. The needle 40 includes a shaft portion 41 as a “needle member”, a seal portion 42 as “one end portion of the needle member”, a flange portion 43, a regulating unit 45, and the like. The shaft portion 41, the seal portion 42, the flange portion 43, and the regulating unit 45 are integrated together so as to be reciprocatingly movable.

The shaft portion 41 is a rod-shaped portion, an end portion of which on the fixed core 30 side is formed in a tubular shape. A flow channel 400 is provided inside of the other end portion of the shaft portion 41 on the fixed core 30 side, and the fuel flows in the flow channel 400 toward the injection nozzle 25. The flow channel 400 communicates with a hole 411 provided in the shaft portion 41 on the valve seat 255 side of the flow channel 400. In other words, the hole 411 allows the flow channel 400 to communicate with an external of the shaft portion 41.

The seal portion 42 is disposed on the end portion of the shaft portion 41 on the valve seat 255 side so as to be abuttable against the valve seat 255. When the seal portion 42 is spaced apart from the valve seat 255 or abuts against the valve seat 255, the needle 40 opens or closes the injection holes 26, and allows or blocks a communication between the inside and the outside of the housing 20.

A sliding contact portion 44 is formed between the shaft portion 41 and the seal portion 42. The sliding contact portion 44 is formed in a cylindrical shape and has an outer wall 441 partially chamfered. A portion of the outer wall 441 in the sliding contact portion 44, which is not chamfered, is slidable on an inner wall of the injection nozzle 25. With the above configuration, the reciprocating movement of the needle 40 on a tip end portion on the valve seat 255 side is guided.

The flange portion 43 is formed in a substantially toric shape and is disposed radially outside the end portion of the shaft portion 41 on the fixed core 30 side. The flange portion 43 is formed to be larger in outer diameter than the shaft portion 41.

The regulating unit 45 is formed in a substantially toric shape and disposed radially outside of the shaft portion 41 on the valve seat 255 side of the flange portion 43 at a predetermined distance from the flange portion 43. The regulating unit 45 is formed to be larger in outer diameter than the shaft portion 41. The movable core 50 is disposed to be reciprocatingly movable between a regulating unit first end face 451 of the regulating unit 45 on the fixed core 30 side and a flange portion end face 431.

The movable core 50 is formed in a tubular shape and made of a magnetic material such as ferritic stainless steel. The movable core 50 is disposed on the valve seat 255 side of the fixed core 30 so as to be reciprocatingly movable relative to the housing 20.

The movable core 50 has a movable core through hole 500 through which the shaft portion 41 is inserted. A movable core first end face 501 of the movable core 50 on the fixed core 30 side is formed to be abuttable against the flange portion end face 431. A movable core second end face 502 of the movable core 50 on the valve seat 255 side is formed to be abuttable against the regulating unit first end face 451. When the seal portion 42 abuts against the valve seat 255, and the regulating unit first end face 451 abuts against the movable core second end face 502, a gap 430 is defined between the flange portion end face 431 and the movable core first end face 501.

The fixed core 30 is welded to the third cylinder member 23 of the housing 20 and is fixed to the inside of the housing 20. The fixed core 30 has a fixed core main body portion 301 and a fixed core abutting portion 302.

The fixed core main body portion 301 is formed in a tubular shape and made of a magnetic material such as ferritic stainless steel. The fixed core main body portion 301 is subjected to the magnetic stabilization treatment, and disposed in a magnetic field developed by the coil 35 to be described later.

The fixed core abutting portion 302 is a cylindrical member that is disposed inside of the fixed core main body portion 301 on the valve seat 255 side. The fixed core abutting portion 302 has a hardness comparable to hardness of the movable core 50. An end face 303 of the fixed core abutting portion 302 on the valve seat 255 side is located closer to the valve seat 255 side than an end face 304 of the fixed core main body portion 301 on the valve seat 255 side. With the above configuration, when the movable core 50 moves in the valve-opening direction, the movable core first end face 501 of the movable core 50 abuts against the end face 303 of the fixed core abutting portion 302 to regulate the movement of the movable core 50 in the valve-opening direction.

The coil 35 is formed in a tubular shape and mainly surrounds the radially outer sides of the second cylinder member 22 and the third cylinder member 23. When receiving an electric power, the coil 35 develops a magnetic field around the coil 35. With the development of the magnetic field, a magnetic circuit is formed in the fixed core 30, the movable core 50, the first cylinder member 21, and the third cylinder member 23.

The first spring 31 is disposed such that one end of the first spring 31 abuts against the movable core first end face 501 of the movable core 50. The other end of the first spring 31 abuts against an end face 111 of an adjusting pipe 11 on the valve seat 255 side, and the adjusting pipe 11 is press-fixed to the inside of the fixed core 30. The first spring 31 urges the movable core 50 in a direction of the valve seat 255, that is, in the valve-closing direction.

One end of the second spring 32 abuts against a spring seat 211 as a “slide member” provided in the first cylinder member 21. The other end of the second spring 32 abuts against a regulating unit second end face 452 of the regulating unit 45 on the valve seat 255 side. The second spring 32 urges the needle 40 in the valve-opening direction.

In the present embodiment, an urging force of the second spring 32 is set to be smaller than an urging force of the first spring 31. With the above configuration, when no electric power is supplied to the coil 35, the seal portion 42 of the needle 40 is in a state to abut against the valve seat 255, that is, in a valve closing state.

The spring seat 211 is disposed on the valve seat 255 side of the regulating unit 45 and radially outside of the shaft portion 41 separately from the first cylinder member 21. The spring seat 211 includes multiple members whose cross-section in a direction perpendicular to the central axis CA0 is formed in an arc shape centered on a point on the central axis CA0. The spring seat 211 is slidable on the shaft portion 41.

A tubular fuel introduction pipe 12 is press-fitted and welded on an end portion of the third cylinder member 23 opposite to the second cylinder member 22 side. A filter 13 is disposed inside of the fuel introduction pipe 12. The filter 13 collects foreign matter contained in the fuel that flows from an introduction port 14 of the fuel introduction pipe 12.

Radially outer sides of the fuel introduction pipe 12 and the third cylinder member 23 are molded with a resin. A connector 15 is formed at the mold part. A terminal 16 for supplying an electric power to the coil 35 is insert-molded in the connector 15. A tubular holder 17 is disposed radially outside of the coil 35 so as to surround the coil 35.

The fuel that flows from the introduction port 14 of the fuel introduction pipe 12 flows inside of the fixed core 30, inside of the adjusting pipe 11, through the flow channel 400 and the hole 411, and between the first cylinder member 21 and the shaft portion 41 and is introduced into the injection nozzle 25. In other words, a path extending from the introduction port 14 of the fuel introduction pipe 12 to a space between the first cylinder member 21 and the shaft portion 41 of the needle 40 configures the fuel passage 18 for introducing the fuel into the injection nozzle 25.

Next, the operation of the fuel injection valve 1 will be described. In the fuel injection valve 1, the distance by which the needle 40 moves, that is, the lift quantity of the needle 40 is different depending on a magnitude of a pressure of the fuel flowing in the fuel passage 18. In this example, cases in which the pressure of the fuel is relatively high and relatively low will be described, separately.

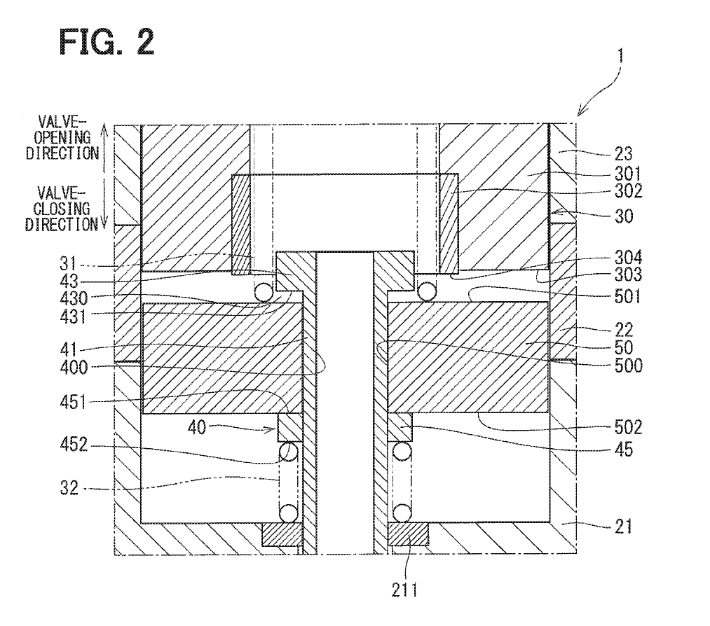

First, when no electric power is supplied to the coil 35, the seal portion 42 of the needle 40 abuts against the valve seat 255. In this situation, the needle 40, the movable core 50, and the fixed core 30 have a positional relationship illustrated in FIG. 2. Specifically, the urging force of the first spring 31 and the urging force of the second spring 32 are exerted on the needle 40 and the movable core 50, the regulating unit first end face 451 abuts against the movable core second end face 502. In this situation, the gap 430 is provided between the movable core first end face 501 and the flange portion end face 431. In addition, because no magnetic attraction force is generated between the fixed core 30 and the movable core 50, a gap is provided between the end face 303 of the fixed core abutting portion 302 and the movable core first end face 501.

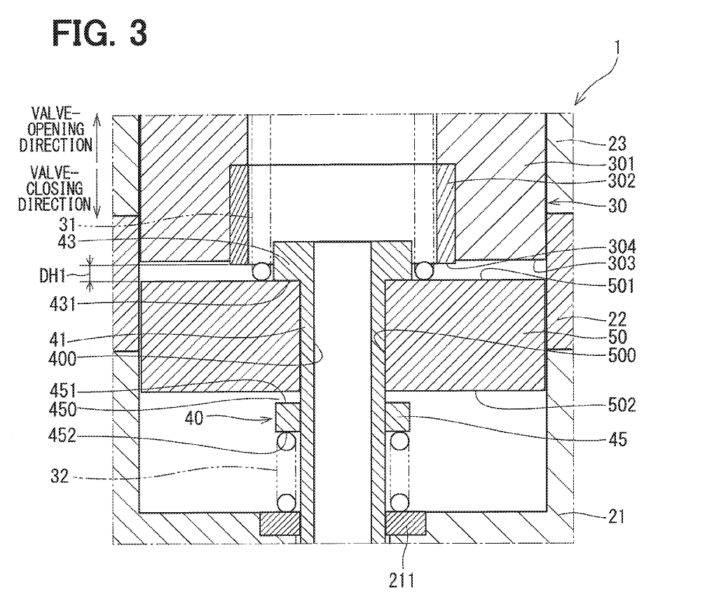

When the electric power is supplied to the coil 35, and a magnetic attraction force is generated between the fixed core 30 and the movable core 50, the movable core 50 moves in the valve-opening direction by a distance corresponding to a length of the gap 430 in the central axis CA0 direction while accelerating. As illustrated in FIG. 3, when the movable core first end face 501 abuts against the flange portion end face 431, because the movable core 50 moving in the valve-opening direction while accelerating collides with the flange portion 43, a relatively large force in the valve-opening direction is exerted on the needle 40. In this situation, a gap 450 is provided between the movable core second end face 502 and the regulating unit first end face 451.

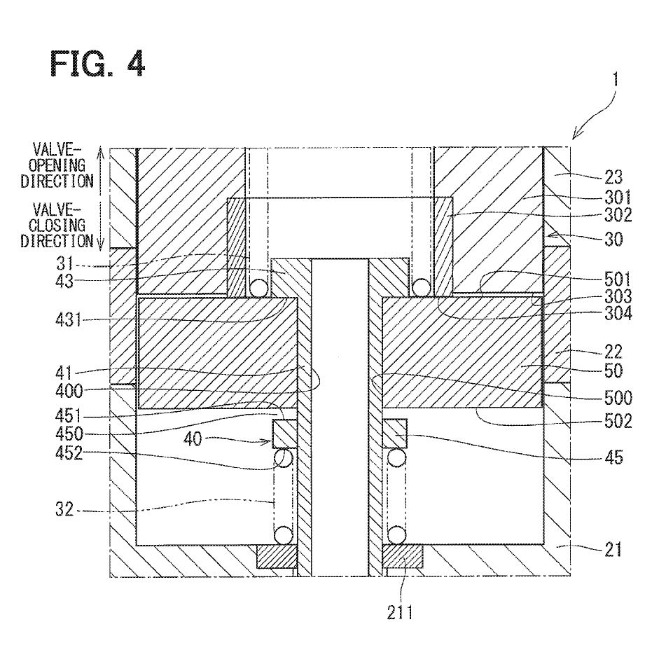

When the movable core 50 moves in the valve-opening direction due to the magnetic attraction force in a state where the movable core first end face 501 abuts against the flange portion end face 431, the seal portion 42 is spaced apart from the valve seat 255, and the injection holes 26 are opened. When the injection holes 26 are opened, the fuel introduced into the injection nozzle 25 is injected toward the outside through the injection holes 26. As illustrated in FIG. 4, when the movable core 50 that moves in the valve-opening direction in a state where the movable core first end face 501 abuts against the flange portion end face 431 abuts against the fixed core abutting portion 302, the movement in the valve-opening direction is stopped.

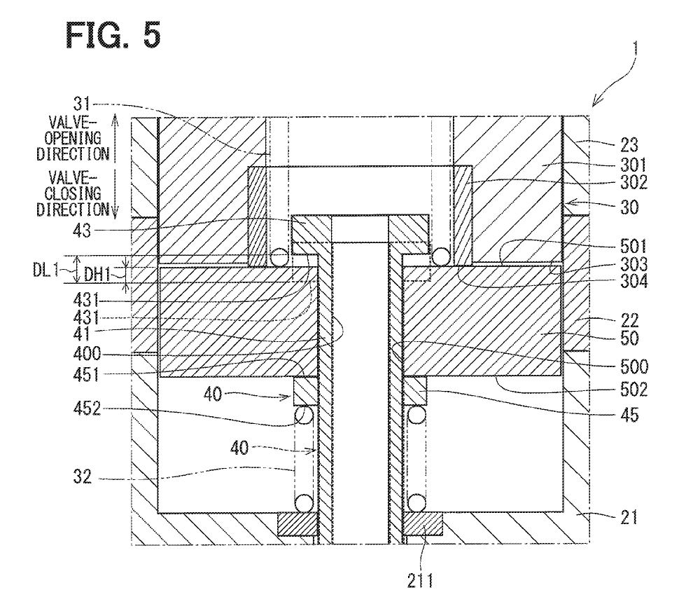

When the fuel flowing in the fuel passage 18 is of a relatively high pressure, after the movable core 50 has abutted against the fixed core abutting portion 302, the movable core first end face 501 of the movable core 50 which abuts against the fixed core abutting portion 302 remains abutted against the flange portion end face 431 without moving the needle 40 in the valve-opening direction. With the above configuration, as illustrated in FIGS. 3 and 5, the lift quantity of the needle 40 when the fuel is of the relatively high pressure is represented by a distance DH1 that is a distance from a position of the flange portion end face 431 of the needle 40 when the seal portion 42 abuts against the valve seat 255 to a position of the end face 303 of the fixed core abutting portion 302. In FIG. 5, the position of the needle 40 when the seal portion 42 abuts against the valve seat 255 is indicated by a dotted line.

On the other hand, when the fuel flowing in the fuel passage 18 is of a relatively low pressure, after the movable core 50 has abutted against the fixed core abutting portion 302, the needle 40 further moves in the valve-opening direction due to the urging force of the second spring 32. Specifically, as illustrated in FIG. 5, the needle 40 moves until the movable core second end face 502 of the movable core 50 that abuts against the fixed core abutting portion 302 abuts the regulating unit first end face 451. With the above configuration, the lift quantity of the needle 40 when the fuel is of the relatively low pressure is represented by a distance DL1 that is a distance from the position of the flange portion end face 431 of the needle 40 where the seal portion 42 abuts against the valve seat 255 to a position of the flange portion end face 431 illustrated in FIG. 5. Since the position of the flange portion end face 431 illustrated in FIG. 5 is away from the valve seat 255 more than the end face 303 of the fixed core abutting portion 302, the distance DL1 is longer than the distance DH1.

When power supply to the coil 35 is stopped, the magnetic attraction force between the fixed core 30 and the movable core 50 is vanished. When the fuel flowing in the fuel passage 18 is of the relatively high pressure, the movable core 50 moves in the valve-closing direction from a state illustrated in FIG. 4 due to the urging force of the first spring 31, and the movable core second end face 502 abuts against the regulating unit first end face 451. After the movable core second end face 502 abuts against the regulating unit first end face 451, the movable core 50 and the needle 40 move in the valve-closing direction due to a difference between the urging force of the first spring 31 and the urging force of the second spring 32. Also, when the fuel flowing in the fuel passage 18 is of the relatively low pressure, because the movable core second end face 502 abuts against the regulating unit first end face 451, the movable core 50 and the needle 40 move in the valve-closing direction due to the difference between the urging force of the first spring 31 and the urging force of the second spring 32.

When the seal portion 42 of the needle 40 which moves in the valve-closing direction abuts against the valve seat 255, the movement of the needle 40 in the valve-closing direction is stopped. As a result, the injection of the fuel from the injection holes 26 is stopped.

In the fuel injection valve 1 according to the first embodiment, when the seal portion 42 abuts against the valve seat 255, and the regulating unit first end face 451 abuts against the movable core second end face 502, the gap 430 is provided between the flange portion end face 431 and the movable core first end face 501. In the fuel injection valve 1, when the electric power is supplied to the coil 35, the movable core 50 abuts against the needle 40 while accelerating by a distance corresponding to the length of the gap 430 in the central axis CA0 direction. Accordingly, in the fuel injection valve 1, the relatively large force in the valve-opening direction can be exerted on the needle 40.

In addition, in the fuel injection valve 1, the second spring 32 that urges the needle 40 in the valve-opening direction abuts against the regulating unit 45 disposed so as to be reciprocatingly movable integrally with the shaft portion 41. In the case where the fuel injection valve 1 opens the valve, when the movable core 50 that moves in the valve-opening direction abuts against the fixed core abutting portion 302 after having abutted against the flange portion 43, the needle 40 is spaced apart from the movable core 50 due to the urging force of the second spring 32, and further moves in the valve-opening direction. As a result, the lift quantity of the needle 40 is longer than the distance by which the movable core 50 moves until the movable core 50 abuts against the fixed core abutting portion 302 since the movable core 50 abuts against the flange portion 43.

Up to now, in the fuel injection valve having the needle supported to the movable core as in the fuel injection valve disclosed in Patent Literature 1, when the injection quantity of the fuel is increased with an increase in the lift quantity of the needle, in order to increase the magnetic attraction force generated between the fixed core and the movable core, there is a need to increase the electric power to be supplied to the coil. On the other hand, in the fuel injection valve 1 according to the present disclosure, as described above, the lift quantity of the needle 40 can be increased without any increase in the electric power to be supplied to the coil 35. As a result, in the fuel injection valve 1, the injection quantity of fuel can be increased while suppressing an increase in the electric power to be supplied to the coil 35.

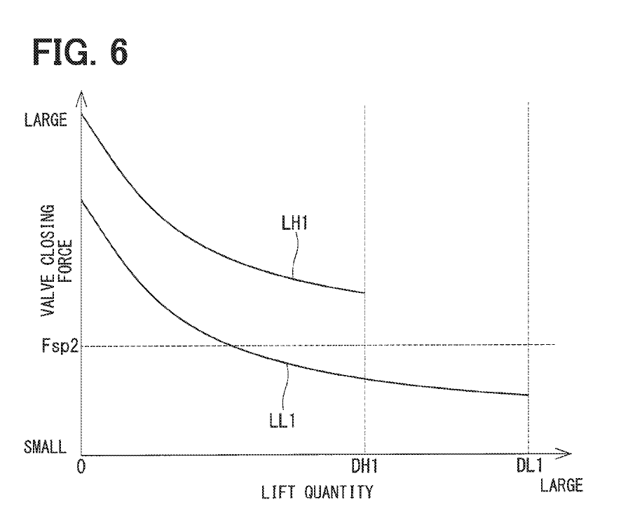

FIG. 6 illustrates a relationship between the lift quantity of the needle 40 and a force (hereinafter referred to as “valve closing force”) in the valve-closing direction to be exerted on the needle 40. In FIG. 6, the axis of abscissa represents the lift quantity of the needle 40, and the axis of ordinate represents the valve closing force. In FIG. 6, a case in which a fuel flowing in the fuel passage 18 is of a relatively high voltage is indicated by a solid line LH1, and a case in which the fuel is of a relatively low voltage is indicated by a solid line LL1.

When the lift quantity is “0”, a difference between the urging force of the first spring 31 and the urging force of the second spring 32 as well as a force (hereinafter referred to as “fuel pressure”) of a value obtained by multiplying seat areas of the seal portion 42 and the valve seat 255 by a pressure of the fuel flowing in the fuel passage 18 is exerted on the needle 40 in the valve-closing direction.

When the fuel flowing in the fuel passage 18 is of the relatively high pressure, because the fuel pressure is relatively high, even when the lift quantity of the needle 40 is the distance DH1, that is, the movable core first end face 501 abuts against the end face 303 of the fixed core abutting portion 302, the valve closing force exerted on the needle 40 is relatively large. Specifically, as illustrated in FIG. 6, the valve closing force is larger than an urging force Fsp2 of the second spring 32. As a result, when the fuel is relatively high, after the movable core 50 abuts against the fixed core abutting portion 302, the needle 40 does not move in the valve-opening direction even due to the urging force of the second spring 32. Therefore, the lift quantity of the needle 40 becomes the distance DH1.

On the other hand, when the fuel flowing in the fuel passage 18 is of the relatively low pressure, because the fuel pressure is relatively low, when the lift quantity of the needle 40 becomes the distance DH1, the valve closing force exerted on the needle 40 becomes smaller than the urging force Fsp2 of the second spring 32 as illustrated in FIG. 6. As a result, when the fuel is relatively low, after the movable core 50 abuts against the fixed core abutting portion 302, the needle 40 moves in the valve-opening direction due to the urging force of the second spring 32. Therefore, the lift quantity of the needle 40 becomes the distance DL1 larger than the distance DH1.

As described above, in the fuel injection valve 1, the lift quantity of the needle 40 is changed according to the pressure of the fuel flowing in the fuel passage 18.

The fuel injection valve 1 includes the fixed core abutting portion 302 having the same hardness as that of the movable core 50. As a result, in the opening/closing operation of the fuel injection valve 1, the fixed core main body portion 301 is prevented from being worn or damaged by the abutment against the movable core 50. Therefore, a reduction in the performance and the damage of the fuel injection valve 1 can be prevented.

The second spring 32 is gradually increased in the urging force when the second spring 32 abuts against the valve seat 255 from a state where the needle 40 is spaced apart from the valve seat 255. An impact when the needle 40 moving in the valve-closing direction collides with the valve seat 255 can be reduced. Therefore, the seal portion 42 and the valve seat 255 can be prevented from being worn, deformed, or damaged.

The needle 40 slides on the spring seat 211 disposed on an inner wall of the first cylinder member 21. With this configuration, an unintentional fuel injection caused by a trouble in the reciprocating movement such as an inclination of the needle 40 can be prevented.

### Second Embodiment

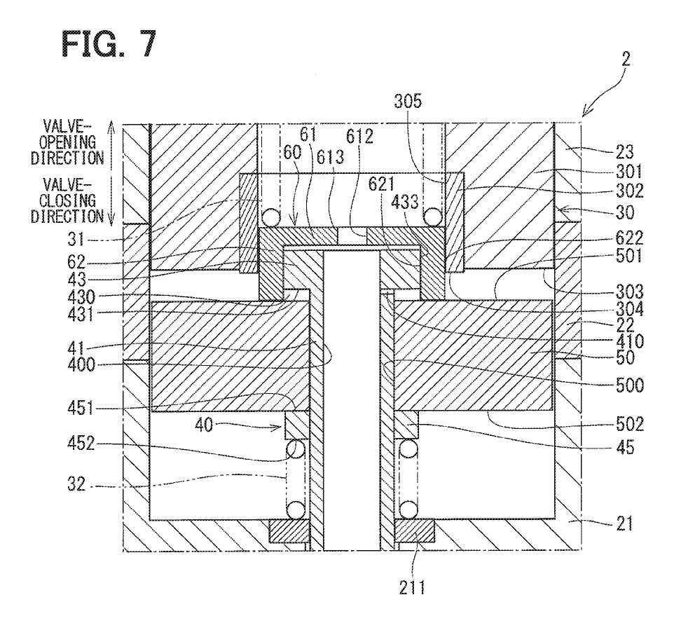

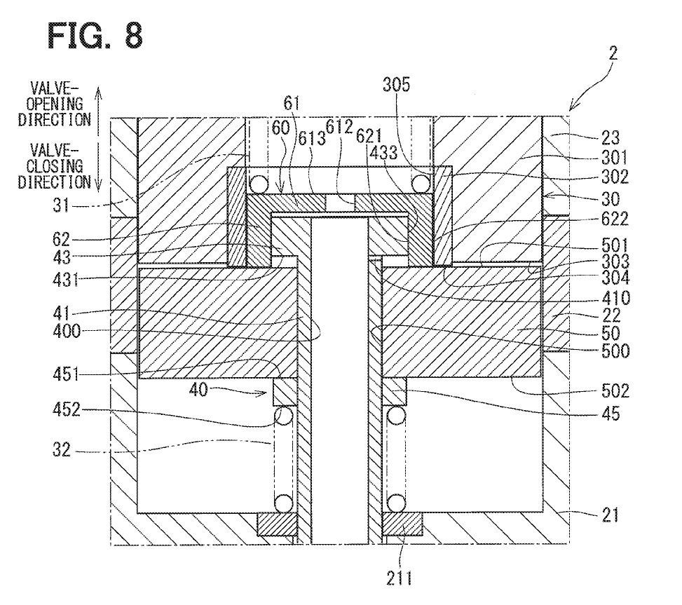

Hereinafter, a fuel injection valve according to a second embodiment of the present disclosure will be described with reference to FIGS. 7 and 8. The second embodiment is different from the first embodiment in that a flange portion accommodation member is provided. The substantially same parts as those in the first embodiment are denoted by identical reference numerals or symbols, and their description will be omitted. FIGS. 7 and 8 illustrate a valve-opening direction and a valve-closing direction in which the valve-opening direction is a direction in which a needle 40 is spaced apart from a valve seat 255 and the valve-closing direction is a direction in which the needle 40 abuts against the valve seat 255.

A fuel injection valve 2 according to the second embodiment includes a bottomed cylindrical member 60 as a “flange portion accommodation member” that houses a flange portion 43 so as to be reciprocatingly movable. FIG. 7 illustrates a main cross-sectional view of the fuel injection valve 2 in a state where the needle 40 abuts against the valve seat 255, and a regulating unit first end face 451 abuts against a movable core second end face 502. FIG. 8 illustrates a main cross-sectional view of the fuel injection valve 2 in a state where the lift quantity of the needle 40 is maximum.

The bottomed cylindrical member 60 is disposed on a side of the movable core 50 opposite to the valve seat 255 and inside of the fixed core abutting portion 302 to be reciprocatingly movable relative to the fixed core 30. The bottomed cylindrical member 60 is formed in a bottomed tubular shape, and includes a disc portion 61 as a “bottomed portion” and a cylinder portion 62. The disc portion 61 and the cylinder portion 62 are integrally formed.

The disc portion 61 is located on a side of the flange portion 43 opposite to the valve seat 255. The disc portion 61 is formed such that its cross section perpendicular to the central axis CA0 is formed in a circular shape. A communication passage 612 is provided in the disc portion 61, and communicates between an inside and an outside of the bottomed cylindrical member 60. The communication passage 612 defines a fuel passage 18, and discharges the fuel inside the bottomed cylindrical member 60 toward the outside due to the movement of the flange portion 43.

The cylinder portion 62 extends toward the valve seat 255 from a radial outside of the disc portion 61. An inner wall 621 of the cylinder portion 62 is formed to be slidable on an outer wall 433 on the radial outside of the flange portion 43. The hardness of the inner wall 621 is the same as that of the outer wall 433. An outer wall 622 of the cylinder portion 62 is disposed to be slidable on an inner wall 305 of the fixed core abutting portion 302. The hardness of the outer wall 622 is the same as that of the inner wall 305.

One end of the cylinder portion 62 is fixed to the disc portion 61. An end portion of the cylinder portion 62 opposite to the end portion fixed to the disc portion 61 of the cylinder portion 62 is disposed to be abuttable against the movable core 50. The cylinder portion 62 has a length as long as the flange portion 43 can reciprocate inside the bottomed cylindrical member 60.

The first spring 31 is disposed such that one end of the first spring 31 abuts against an end face 613 of the disc portion 61 on the side opposite to the valve seat 255. The first spring 31 urges the movable core 50 through the bottomed cylindrical member 60 in the direction of the valve seat 255, that is, in the valve-closing direction.

The shaft portion 41 has a communication passage 410 that communicates between a gap 430 and the flow channel 400. A fuel that flows into or out of a gap 430 with a change in a length of the gap 430 in a central axis CA0 direction passes through a communication passage 410.

In the fuel injection valve 1, when the pressure of the fuel flowing in the fuel passage 18 is relatively low, the needle 40 moves until the movable core second end face 502 abuts against the regulating unit first end face 451 as illustrated in FIG. 8, after the flange portion end face 431 abuts against the movable core first end face 501. As a result, the needle 40 can move by a distance longer than the distance by which the movable core 50 moves until the movable core 50 abuts against the fixed core abutting portion 302 since the movable core 50 abuts against the flange portion 43. Therefore, the second embodiment obtains the same advantages as those in the first embodiment.

In addition, in the fuel injection valve 2, the needle 40 reciprocates while an outer wall 433 and an inner wall 621 slide on each other. Therefore, the reciprocating movement of the needle 40 is guided. Also, the bottomed cylindrical member 60 reciprocates while an outer wall 622 and an inner wall 305 slide on each other. As a result, the reciprocating movement of the bottomed cylindrical member 60 is guided. In this way, the reciprocating movement of the needle 40 in the direction of the central axis CA0 is guided by the bottomed cylindrical member 60 and the fixed core 30. Therefore, an unintentional fuel injection caused by a trouble in the reciprocating movement such as an inclination of the needle 40 can be further prevented.

Also, in the fuel injection valve 2, the inner wall 621 of the cylinder portion 62 has the same hardness as that of the outer wall 433 of the flange portion 43. With this configuration, a wear in the sliding between the cylinder portion 62 and the flange portion 43 can be suppressed.

In addition, the outer wall 622 of the cylinder portion 62 has the same hardness as that of the inner wall 305 of the fixed core abutting portion 302. With this configuration, a wear in the sliding between the cylinder portion 62 and the fixed core abutting portion 302 can be suppressed.

### Third Embodiment

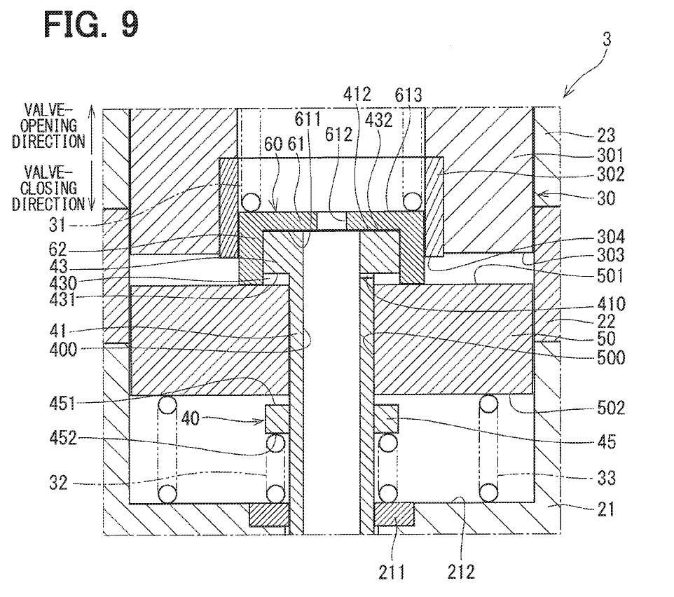

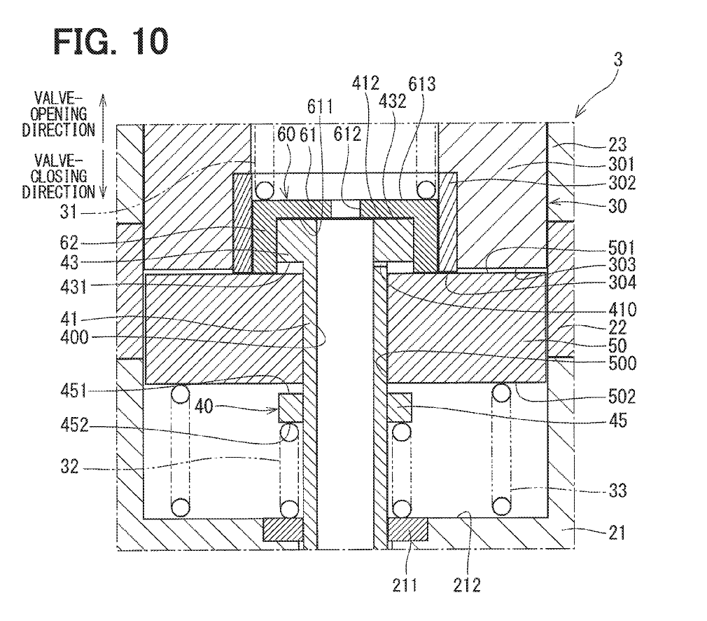

Hereinafter, a fuel injection valve according to a third embodiment of the present disclosure will be described with reference to FIGS. 9 and 10. The third embodiment is different from the second embodiment in a portion abutted when a needle is most lifted. The substantially same parts as those in the second embodiment are denoted by identical reference numerals or symbols, and their description will be omitted. FIGS. 9 and 10 illustrate a valve-opening direction and a valve-closing direction in which the valve-opening direction is a direction in which a needle 40 is spaced apart from a valve seat 255 and the valve-closing direction is a direction in which the needle 40 abuts against the valve seat 255.

In a fuel injection valve 3 according to the third embodiment, a disc portion 61 of a bottomed cylindrical member 60 is formed so as to be abuttable against a shaft portion 41 and a flange portion 43. Specifically, an end face 611 of the disc portion 61 on the valve seat 255 side is formed to be abuttable against an end face 412 of the shaft portion 41 on the side opposite to the valve seat 255 and an end face 432 of the flange portion 43 on the side opposite to the valve seat 255. Incidentally, in the present embodiment, because an end face 412 is flush with an end face 432, an end face 611 is flat.

In the fuel injection valve 3, a third spring 33 is disposed on a valve seat 255 side of a movable core 50. One end of the third spring 33 abuts against a movable core second end face 502. The other end of the third spring 33 abuts against an inner wall 212 of a first cylinder member 21. The third spring 33 urges the movable core 50 in the valve-opening direction.

In the fuel injection valve 3, when a power supply to a coil is stopped, and a magnetic attraction force is vanished, the needle 40 and the movable core 50 are moved in the valve-closing direction due to an urging force of a first spring 31. When the seal portion 42 abuts against the valve seat 255, the movement of the needle 40 in the valve-closing direction is stopped whereas the movable core 50 further moves in the valve-closing direction due to an inertial force. When the inertial force when the needle 40 is spaced apart from the movable core 50 is larger than the urging force of the third spring 33, the movable core 50 abuts against the regulating unit 45, and the movement of the movable core 50 in the valve-closing direction is stopped. In this situation, a gap 430 is provided between a flange portion end face 431 and a movable core first end face 501.

In the fuel injection valve 3, when the fuel flowing in the fuel passage 18 is of the relatively low pressure, the needle 40 further moves in the valve-opening direction until the end faces 412 and 432 of the needle 40 abut against an end face 611 of the bottomed cylindrical member 60 as illustrated in FIG. 10 after the flange portion end face 431 abuts against the movable core first end face 501. As a result, the needle 40 can move by a distance longer than the distance by which the movable core 50 moves until the movable core 50 abuts against the fixed core abutting portion 302 since the movable core 50 abuts against the flange portion 43. Therefore, the third embodiment obtains the same advantages as those in the second embodiment.

Further, in the fuel injection valve 3, when the movable core 50 moves in the valve-closing direction from a state where the movable core first end face 501 abuts against the flange portion end face 431, a moving speed of the movable core 50 in the valve-closing direction is decreased due to the urging force of the third spring 33. As a result, even when the movable core 50 moving in the valve-closing direction collides with the regulating unit 45, an impact of the collision can be reduced. Therefore, the movable core 50 and the needle 40 can be prevented from being damaged.

### Fourth Embodiment

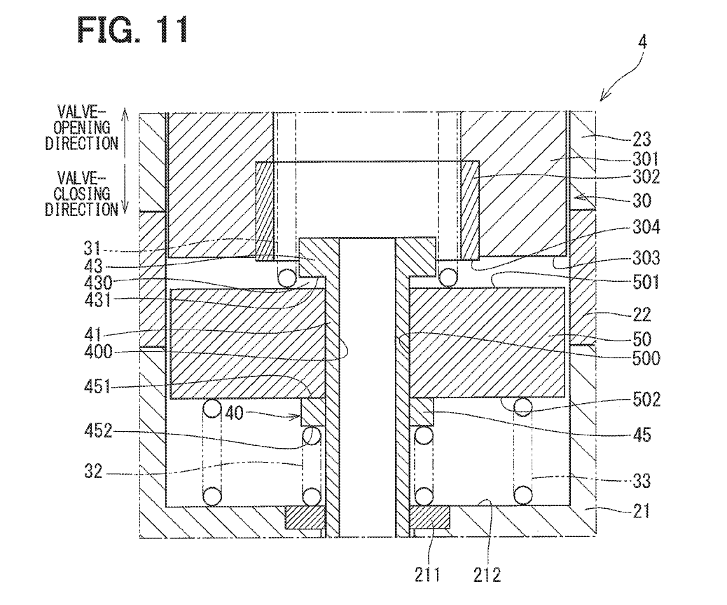

Hereinafter, a fuel injection valve according to a fourth embodiment of the present disclosure will be described with reference to FIG. 11. The fourth embodiment is different from the first embodiment in that a third urging member is provided. The substantially same parts as those in the first embodiment are denoted by identical reference numerals or symbols, and their description will be omitted. FIG. 11 illustrates a valve-opening direction and a valve-closing direction in which the valve-opening direction is a direction in which a needle 40 is spaced apart from a valve seat 255 and the valve-closing direction is a direction in which the needle 40 abuts against the valve seat 255.

In the fuel injection valve 4 according to the fourth embodiment, a third spring 33 is disposed on the valve seat 255 side of a movable core 50. One end of the third spring 33 abuts against a movable core second end face 502. The other end of the third spring 33 abuts against an inner wall 212 of a first cylinder member 21. The third spring 33 urges the movable core 50 in the valve-opening direction.

In the fuel injection valve 4, when the movable core 50 moves in the valve-closing direction from a state where the movable core first end face 501 abuts against the flange portion end face 431, a moving speed of the movable core 50 in the valve-closing direction is decreased due to the urging force of the third spring 33, and an impact when the movable core 50 collides with the regulating unit 45 can be reduced. Therefore, the fourth embodiment can obtain the same advantages as those in the first embodiment, and can prevent the movable core 50 and the needle 40 from being damaged.

### Another Embodiment

In the above embodiments, the slide member for guiding the reciprocating movement of the shaft portion is provided. However, the slide member may be omitted.

In the embodiments described above, the fixed core includes the fixed core main body portion and the fixed core abutting portion. However, the fixed core abutting portion may be omitted.

In the third embodiment, in the bottomed cylindrical member, the inner wall of the cylinder portion slides on the outer wall of the flange portion and the outer wall of the tubular portion slides on the inner wall of the fixed core abutting portion. However, the inner wall and the outer wall of the cylinder portion may not slide on the outer wall of the flange portion and the inner wall of the fixed core abutting portion, respectively. The movement of the needle in the valve-opening direction may be stopped.

In the embodiments described above, the flange portion and the regulating unit are formed in the substantially toric shape. However, the shape of the flange portion and the regulating unit is not limited to the above configuration. The shape may be an elliptical cylindrical shape or a polygonal cylindrical shape, and the flange portion and the regulating unit may be disposed in a protruding shape in the circumferential direction of the shaft portion.

The above embodiments include the spring seat against which one end of the second spring abuts, and which can slide on the shaft portion. However, the spring seat may not slide on the shaft portion.

The present disclosure has been described based on the embodiments; however, it is understood that this disclosure is not limited to the embodiments or the structures. The present disclosure includes various modification examples, or modifications within an equivalent range. In addition, various combinations or forms, and other combinations or forms including only one element, more than or less than one among these combinations or forms are included in the scope or the technical scope of the present disclosure.

1. A fuel injection valve comprising:
a housing that has an injection hole that is defined on one end in a central axis and injects a fuel, and a valve seat that is formed around an opening of the injection hole;
a fixed core that is fixed to an inside of the housing;
a needle member that is disposed to be reciprocatingly movable in the housing, closes a valve when one end portion of the needle member abuts against the valve seat, and opens the valve when the one end portion of the needle member is lifted from the valve seat;
a flange portion that is disposed radially outside of the other end portion of the needle member to be reciprocatingly movable integrally with the needle member;
a movable core that is disposed to be movable relative to the needle member on the valve seat side of the flange portion;
a regulating unit that is disposed radially outside of the needle member on the valve seat side of the movable core to be reciprocatingly movable integrally with the needle member, and abuts against the movable core to regulate the movement of the movable core in the valve-closing direction;
a coil that develops a magnetic field to cause the movable core to be attracted to the fixed core when receiving an electric power;
a first urging member that urges the needle member in the valve-closing direction; and
a second urging member one end portion of which abuts against the regulating unit to urge the needle member in the valve-opening direction through the regulating unit, wherein
when the regulating unit abuts against the movable core, a gap is defined between the flange portion and the movable core.

2. The fuel injection valve according to claim 1, further comprising:
a flange portion accommodation member that has an end portion on the valve seat side formed to be abuttable against the movable core, and which houses the flange portion to be reciprocatingly movable, wherein
the first urging member has one end portion abutted against the flange portion accommodation member, and urges the needle member in the valve-closing direction through the flange portion accommodation member, the movable core, and the regulating unit.

3. The fuel injection valve according to claim 2, wherein
the flange portion accommodation member is formed in a bottomed tubular shape, and
the flange portion accommodation member includes a bottomed portion against which one end portion of the first urging member abuts, and a cylinder portion that extends in a direction of the valve seat from the bottomed portion, and has an end portion on the valve seat side formed to be abuttable against the movable core.

4. The fuel injection valve according to claim 3, wherein
the cylinder portion includes an inner wall that slides on an outer wall on a radial outside of the flange portion.

5. The fuel injection valve according to claim 4, wherein
the inner wall of the cylinder portion is identical in hardness with the outer wall of the flange portion.

6. The fuel injection valve according to claim 3, wherein
the cylinder portion has an outer wall that slides on an inner wall of the fixed core.

7. The fuel injection valve according to claim 6, wherein
the inner wall of the fixed core is identical in hardness with the outer wall of the cylinder portion.

8. The fuel injection valve according to claim 1, wherein
the housing has a slide member that is disposed on the valve seat side of the regulating unit, and has an inner wall sliding on an outer wall of the needle member.

9. The fuel injection valve according to claim 1, further comprising a third urging member that has one end abutted against the movable core, and the other end abutted against an inner wall of the housing, and urges the movable core in the valve-opening direction.

10. The fuel injection valve according to claim 1, wherein
the fixed core includes an abutting portion that has the same hardness as that of the movable core, and is abuttable against the movable core.
